(19) United States
(12) Patent Application Publication
(10) Pub. No.: US 2024/0364613 A1
(43) Pub. Date: Oct. 31, 2024

(54) NETWORK OFFENDER IDENTIFICATION SYSTEM AND METHOD

(71) Applicant: Rakuten Mobile, Inc., Tokyo (JP)

(72) Inventor: Amit AGRAWAL, Tokyo (JP)

(21) Appl. No.: 18/247,272

(22) PCT Filed: Sep. 23, 2022
(86) PCT No.: PCT/US2022/044508

§ 371 Date: Mar. 30, 2023

(51) Int. Cl. H04L 43/16; H04L 43/045; H04L 43/091

(52) U.S. Cl. CPC H04L 43/16; H04L 43/045; H04L 43/091

(57) ABSTRACT

A method includes displaying trend data of a network in a first user interface module, wherein the network includes a plurality of sites, each site of the plurality of sites generates a corresponding performance indicator, and the trend data include values of a network performance indicator corresponding to the performance indicators of the plurality of sites. In response to a network performance indicator value having a predefined relationship to a first threshold level, an annotation to the first user interface module is activated, the annotation including a representation of a value of the performance indicator of a site of the plurality of sites having the predefined relationship to a second threshold level. In response to a user input associated with the annotation, performance data of the site of the plurality of sites is displayed in a second user interface module.

### BACKGROUND

In telecommunication and other network environments, total numbers of network sites and other elements can number 50,000 or more. The various sites and elements are typically managed through performance indicators, e.g., key performance indicators (KPIs), and alarms that are monitored and used to trigger appropriate actions. Performance indicators such as availability, accessibility, retainability, integrity, and mobility apply to individual network sites and to aggregations of network sites, e.g., based on geographic locations, up to a top network level.

Alarms are generated by both hardware and software elements for a wide variety of reasons. An alarm is a data record including one or more indicators and/or descriptors typically triggered by at least one monitored parameter meeting or exceeding a predetermined threshold condition. Real-time network surveillance and fault management therefore relies on the ability to quickly and accurately identify sources of network underperformance and alarm generation.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 illustrates a mobile telecommunication network according to at least one embodiment.

FIG. 2 illustrates an annotated user interface module according to at least one embodiment.

FIGS. 3A and 3B illustrate user interface modules according to at least one embodiment.

FIG. 4 illustrates network offender identification attributes according to at least one embodiment.

FIG. 5 is a flowchart of a network offender identification method according to at least one embodiment.

FIG. 6 illustrates a network offender identification system according to at least one embodiment.

### DETAILED DESCRIPTION

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not indicate a relationship between the various embodiments and/or configurations discussed.

In various embodiments, a network offender identification system and method include displaying trend data of a network performance indicator in a first user interface module, and in response to a value of the network performance indicator having a predefined relationship to a first threshold level, activating an annotation to the first user interface module, the annotation including a representation of a value of the performance indicator of a site having the predefined relationship to a second threshold level, and in some embodiments including an alarm count. In response to a user input associated with the annotation, a second user interface module is used to display performance data including the site performance indicator and/or individual alarm data.

By including the annotation linked to site-based performance data in the trend data display, the time required to identify a source (offender) of a network performance indicator being outside a target value is significantly reduced compared to approaches in which trend data displays do not include such annotations. Compared to other approaches in which iterative filtering of trend data is used to identify network offenders, system resource loading is also reduced. In some embodiments, compared to approaches in which performance indicator data and alarm data are separately accessed, network offender identification efficiency is further improved by including alarm data in the performance data.

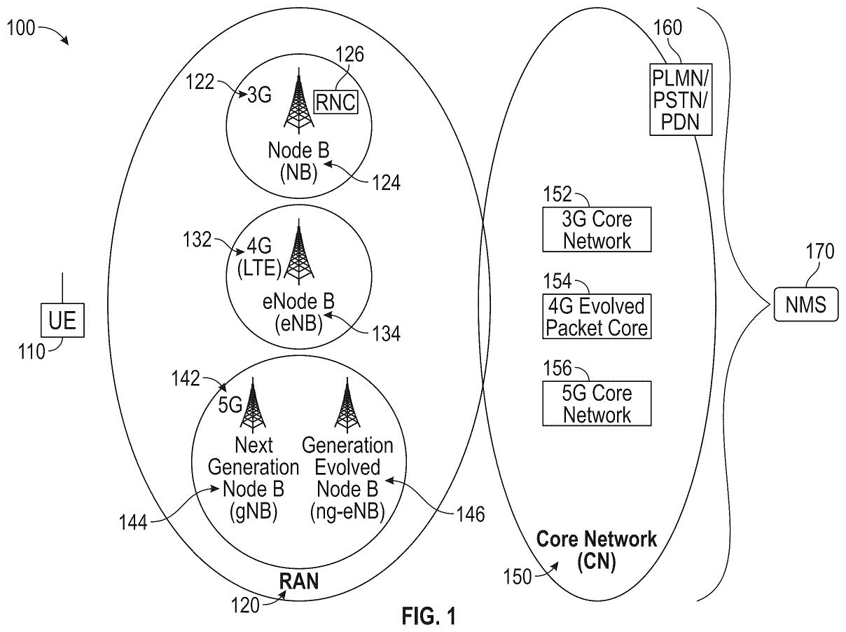

FIG. 1 illustrates a mobile telecommunication network 100 according to at least one embodiment. Mobile telecommunication network 100 is a non-limiting example of a network configured to include some or all of the network offender identification features discussed below.

As depicted in FIG. 1, mobile telecommunication network 100, also referred to as network 100 in some embodiments, includes User Equipment (EU) 110 coupled through a Radio Access Network (RAN) 120 to a Core Network (CN) 150. RAN 120 connects individual devices such as User Equipment (EU) 110 to other parts of network 100, e.g., CN 150, through radio connections. RAN 120 is responsible for managing radio resources, including strategies and algorithms for controlling power, channel allocation, and data rate.

In a 3G network 122, RAN 120 includes the base station, which is called a Node B (NB) 124, and a Radio Network Controller (RNC) 126. RNC 126 controls and manages the radio transceivers in Node Bs 124, as well as manages operational functions, such as handoffs, and the radio channels. The RNC 126 handles communication with the 3G Core Network 152.

In a 4G (LTE) network 132, the Evolved Node B (eNodeB or eNB) 134 is the radio base station. The eNodeB 134 is able to perform the radio access functions that are equivalent to the combined work that Node B and RNC do in 3G and connect to the Evolved Packet Core 154.

In a 5G network 142, there are two types of radio base station nodes: Next Generation Node B (gNodeB) 144 and Next Generation Evolved Node B (ng-eNB) 146. The ng-eNB 146 is an enhanced version of 4G eNodeB and connects 5G UE 110 to the 5G Core Network (5GC) 156 using 4G LTE air interface. The gNB 144 allows 5G UE 110 to connect with a 5GC 156 using 5G NR air interface. The gNBs 144 and ng-eNBs 146 are interconnected with each other by means of the Xn interface. The gNBs 144 and ng-eNBs 146 are also connected by means of the NG interfaces to the 5GC 156.

In some embodiments, RAN 120 is referred to as a network site or cell. In some embodiments, a network site refers to a localized collection of instances of RAN 120.

Core Network (CN) 150 connects RAN 120 to networks 160, such as a Public Landline Mobile Network (PLMN), a Public Switched Telephone Network (PSTN), or a Packet Data Network (PDN). CN 150 provides high-level traffic aggregation, routing, call control/switching, user authentication and charging. The 3G CN 152 includes two different domains (not shown): circuit switched elements and packet switched elements. The 4G Evolved Packet Core (EPC) 154 includes four main network elements (not shown): the Serving Gateway (S-GW), the packet data network (PDN) Gateway (P-GW), the mobility management entity (MME), and the Home Subscriber Server (HSS). The S-GW routes and forwards data packets from the UE and acts as the mobility anchor during inter-eNodeB handovers. The P-GW acts as an ingress and egress point to the EPC from a PDN (Packet Data Network) such as the Internet. The MME manages UE access network and mobility, as well as establishing the bearer path for the UE. The MME is also concerned with the bearer activation/deactivation process. The HSS is the master database for a given subscriber, acting as a central repository of information for network nodes. Subscriber related information held by the HSS includes user identification, security, location, and subscription profile. The EPC is connected to the external networks, which includes the IP Multimedia Core Network Subsystem (IMS). 5GC 156 supports new network functions (NFs) associated with the packet core and user data management domains. 5GC 156 provides a decomposed network architecture with the introduction of a service-based interface (SBI), and control plane and user plane separation (CUPS). 5GC decomposes the 4G MME into an Access and Mobility Management Function (AMF) and a Session Management Function (SMF). The AMF receives connection and session related information from the UE, but is responsible for handling connection and mobility management tasks. Messages related to session management are forwarded to the SMF.

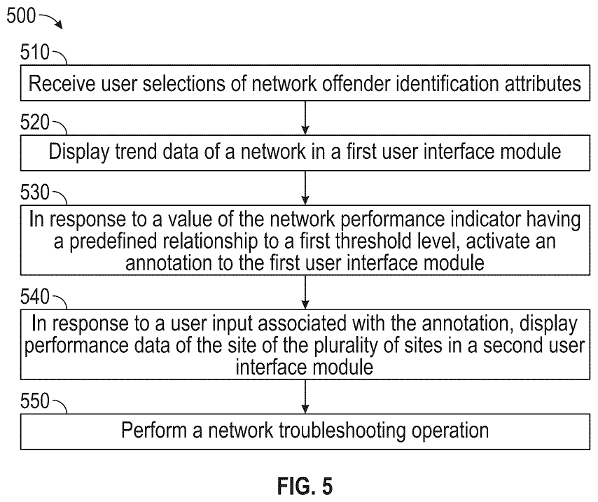

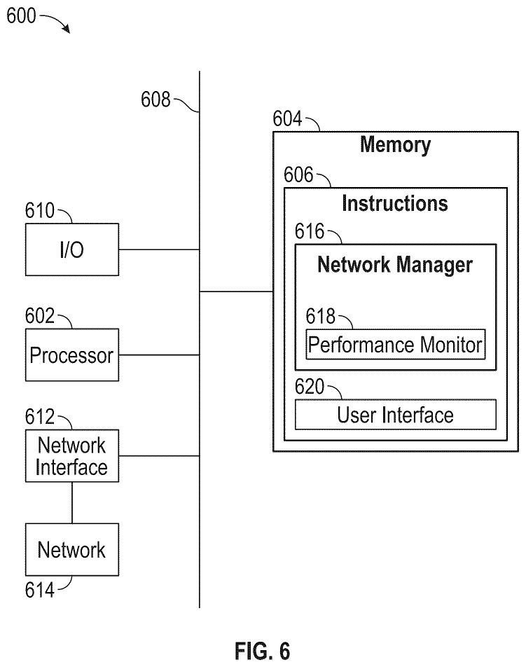

Network 100 includes a network management system (NMS) 170, which provides several network management functions including fault management, in which diagnosing and addressing network faults takes place. As discussed below, NMS 170, also referred to as a network offender identification system in some embodiments, is configured to perform some or all of a network offender identification method, e.g., a method 500 discussed below with respect to FIG. 5. In some embodiments, NMS 170 includes or is included in a network offender identification system 600 discussed below with respect to FIG. 6. In some embodiments, NMS 170 is included in a network other than network 100, e.g., a network that is not configured as a mobile telecommunication network.

NMS 170 includes one or more processors and one or more non-transient storage devices storing computer-readable instructions configured to perform management functions of network 100. In some embodiments, NMS 170 includes a network manager (NM), e.g., a network manager 616 discussed below with respect to FIG. 6, coupled to at least one element manager (EM) (not shown), each of which is further coupled to the various elements of network 100.

NMS 170 includes interfaces configured to enable communication with network 100, thereby supporting management of multivendor and multi-technology network elements. In some embodiments, NMS 170 includes operations systems (OS) (not shown), also referred to as an operations support system (OSS) in some embodiments, configured to provide fault management services and functions to one or more network users on top of the network element management layer of NMS 170, e.g., the NM.

The various sites of network 100, e.g., RAN 120, are configured to, in operation, generate performance indicators, e.g., key performance indicators (KPIs), including data representative of ongoing functional capabilities related to UE 110 communications. Non-limiting examples of such site-level performance indicators include availability, accessibility, retainability, integrity, and mobility indicators.

NMS 170 is configured to, in operation, receive the site-level performance indicators from multiple network sites and, in some embodiments, generate network-level performance indicators by aggregating or otherwise combining the received site-level performance indicators. In some embodiments, NMS 170 is configured to receive the network-level performance indicators from one or more sources, e.g., a network performance analyzer, external to NMS 170. In some embodiments, the network-level performance indicators are generated separately from the site-level performance indicators.

The various network elements, e.g., components of RAN 120, are configured to, in operation, detect fault or other target conditions using autonomous self-check circuits/procedures to monitor operational activities, e.g., measurements, parameters, and/or counters, relative to various thresholds. In various embodiments, the thresholds are predefined by network element manufacturers and executed autonomously, or are based on dynamic operational and/or performance conditions as administered by NMS 170. The network elements are configured to respond to the monitored activity meeting or exceeding corresponding thresholds by generating alarms and communicating the alarms to NMS 170. Non-limiting examples of alarm types include the following categories:
Hardware failures, e.g., a malfunction of a physical resource such as a power supply unit (PSU) within a network element.
Software problems, e.g., software bugs, database inconsistencies.
Functional faults, e.g., a failure of a monitored functional resource in a network element for which no hardware component is found responsible for the failure.
Loss of some or all of a specified capability of a network element due to an overload situation.
Communication failures between various network components, e.g., between NMS 170 and RAN 120.

NMS 170 is configured to, in operation, interact with one or more users (not shown) through one or more input/output (I/O) devices and/or through one or more network interfaces using a graphical user interface (GUI), e.g., I/O devices 610, network interface 612, and user interface 620 discussed below with respect to FIG. 6. NMS 170 is thereby configured to output trend data to the one or more users, the trend data including a graphical representation of network-level performance indicator values over time.

NMS 170 is configured to cause the trend data of a selected network performance indicator to be displayed in a first user interface module, e.g., a window, tab, panel, or other predefined region of the GUI. In addition to the trend data, the first user interface module includes one or more annotations activated based on the trend data including at least one network performance indicator value having a predefined relationship to a first threshold level, e.g., having a value less than, less than or equal to, greater than, greater than or equal to, or equal to the first threshold level. In various embodiments, activating the one or more annotations includes enabling the display of the one or more annotations in or overlaying the first user interface module either based solely on the at least one network performance indicator value or based on a user input in addition to the at least one network performance indicator value.

The annotation includes a representation of the performance indicator of one or more sites of network 100 having the predefined relationship to a second threshold level, e.g., having a value below the second threshold level. In some embodiments, the representation includes an indication of the total number of sites at which the site performance indicator has the predefined relationship to the second threshold level. In some embodiments, the representation includes one or more indications of performance indicator selection criteria, e.g., a maximum number of sites to include, or the predefined relationship of the site performance indicator to the second threshold level.

In some embodiments, the representation includes an alarm count of alarms received from the sites at which at least one site performance indicator value has the predefined relationship to the second threshold level. In some embodiments, the representation includes one or more indications of alarm selection criteria, e.g., an alarm characteristic, or an alarm inclusion time range relative to one or more times at which a value of the network performance indicator has the predefined relationship to the first threshold level.

In various embodiments, NMS 170 is configured to, in operation, cause the annotation to be displayed based solely on the at least one network performance indicator value having the predefined relationship to the first threshold level, or to be displayed further based on receiving a user input to the first user interface module, e.g., a mouse-click at a selection button. In some embodiments, NMS 170 is configured to cause the annotation to be displayed further based on receiving the user input associated with the network performance indicator having the predefined relationship to the first threshold level, e.g., moving a cursor over a region of the trend data corresponding to the at least one network performance indicator value having the predefined relationship to the first threshold level.

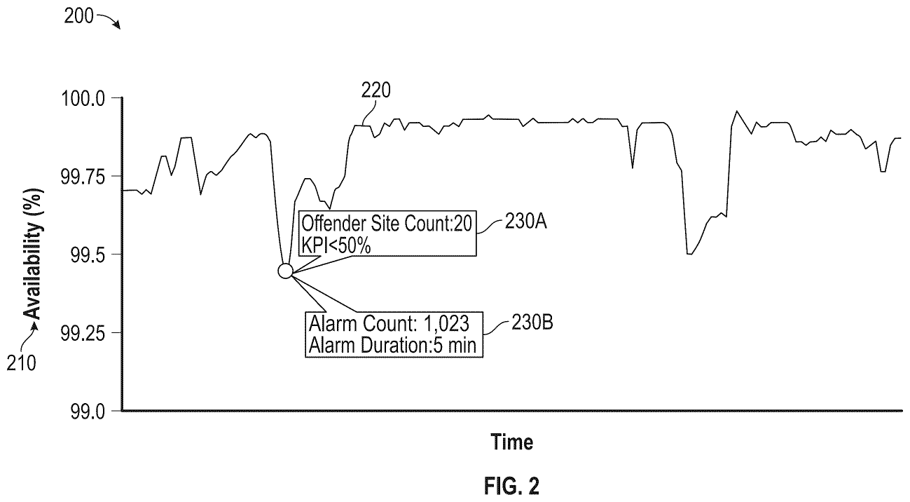

FIG. 2 illustrates an annotated user interface module 200 according to at least one embodiment. User interface module 200 is a non-limiting example provided for the purpose of illustration. Other annotated user interface module configurations are within the scope of the present disclosure.

In the embodiment depicted in FIG. 2, NMS 170 is configured to, in operation, display user interface module 200 including values of a network performance indicator 210 plotted over time as trend data 220. Network performance indicator 210 corresponds to an availability represented as a percentage in which trend data 220 has values ranging from less than 99.5% to greater than 99.75%. In various embodiments, network performance indicator 210 corresponds to a network performance indicator other than the availability, the network performance indicator is represented other than as a percentage, and/or trend data 220 has a range of values other than that depicted in FIG. 2.

User interface module 200 includes an annotation 230A including representations of the site performance indicator corresponding to network performance indicator 210, and an annotation 230B including representations of associated alarm information. In the embodiment depicted in FIG. 2, annotation 230A includes a number of sites (Offender site count: 20) and a predetermined relationship of the site performance indicator to the second threshold level (KPI<50%). Annotation 230B includes an alarm count (Alarm Count: 1,023) and an alarm inclusion time range (Alarm Duration: 5 min) relative to one or more times, i.e., data points of trend data 220, at which network performance indicator 210 has a value less than a first threshold level of 99.5%.

Annotations 230A and 230B depicted in FIG. 2 are non-limiting examples provided for the purpose of illustration. NMS 170 configured to display annotations otherwise configured or including representations other than those depicted in FIG. 2 is within the scope of the present disclosure. In various embodiments, user interface module 200 does not include annotation 230B, annotation 230B is user-selectable, or the site performance indicator and alarm representations are included in a single annotation, e.g., annotation 230A.

In the embodiment depicted in FIG. 2, NMS 170 is configured to, in operation, display user interface module 200 including annotations 230A and 230B in response to a user input causing a cursor to hover over a portion of trend data 220 corresponding to network performance indicator 210 having values below the first threshold level of 99.5%. NMS 170 being otherwise configured to display annotations 230A and 230B, e.g., based solely on trend data 220 including network performance indicator 210 values below the first threshold level of 99.5%, is within the scope of the present disclosure.

NMS 170 is configured to, in operation, respond to a user input associated with one of annotations 230A or 230B by displaying performance data of at least one site in a second user interface module. In various embodiments, the user input includes a mouse-click or other selection activity corresponding to the cursor being within a selection region corresponding to one of annotations 230A or 230B or to a separate region, e.g., a button, within user interface module 200. In various embodiments, the second user interface module is a window, tab, panel, or other predefined region of the GUI being a same or different type as that of the first user interface module.

In some embodiments, NMS 170 is configured to display the performance data including the site performance indicator value of at least one site at which the site performance indicator value has the predetermined relationship to the second threshold level, e.g., a lowest site performance indicator value. In some embodiments, NMS 170 is configured to display the performance data including the site performance indicator values of each site at which the site performance indicator value has the predetermined relationship to the second threshold level. In some embodiments, NMS 170 is configured to display the performance data including a limited number of site performance indicator values, e.g., based on a user defined maximum.

In some embodiments, NMS 170 is configured to display the performance data including individual alarm data corresponding to some or all of the sites at which at least one site performance indicator value has the predetermined relationship to the second threshold level. In various embodiments, the individual alarm data include one or more alarm data records including one or more of a time stamp, an alarm identifier such as an alarm code, an alarm name, an alarm type, an alarm category, a network element identifier, a vendor identifier, a priority indicator, a service impact indicator, a severity indicator, one or more parameter values, or the like.

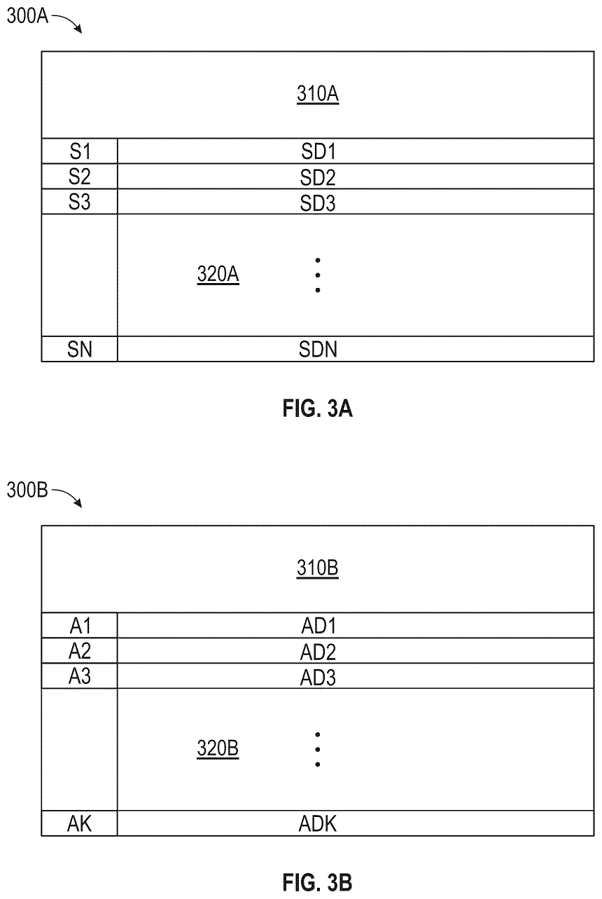

FIGS. 3A and 3B illustrate respective user interface modules 300A and 300B according to at least one embodiment. Each of user interface modules 300A and 300B is a non-limiting example provided for the purpose of illustration. Other user interface module configurations are within the scope of the present disclosure.

In the embodiments depicted in FIGS. 3A and 3B, NMS 170 is configured to, in operation, display user interface module 300A in response to receiving a user input associated with annotation 230A, and in some embodiments, display user interface module 300B in response to receiving a user input associated with annotation 230B.

User interface module 300A includes top-level data 310A and site data 320A. Top-level data 310A include one or more of the site performance indicator, the predefined relationship to the second threshold level, corresponding network performance indicator value(s), or other network-level information.

Site data 320A include a listing S1-SN of a number N, e.g., a maximum number, of sites for which data are included in site data 320A. For each site in listing S1-SN, site data 320A include corresponding individual site data SD1-SDN. Each individual site data SD1-SDN include at least one corresponding site performance indicator value. In some embodiments, individual site data SD1-SDN include multiple site performance indicator values representing a predetermined time span relative to one or more times at which a value of the network performance indicator has the predetermined relationship to the first threshold level.

One or both of listing S1-SN or individual site data SD1-SDN include an identifier of the corresponding site and, in some embodiments, additional site-related information, e.g., a geographic region identifier.

User interface module 300B includes top-level data 310B and alarm data 320B. Top-level data 310B include one or more of the alarm count, the site performance indicator, the predefined relationship to the second threshold level, corresponding network performance indicator value(s), or other network-level information.

Alarm data 320B include a listing A1-AK of a number K, e.g., a maximum number, of alarms, alarm types, or corresponding sites for which data are included in alarm data 320B. For each alarm in listing A1-AK, alarm data 320B include corresponding individual alarm data AD1-ADK. Each individual alarm data AD1-ADK include at least one corresponding alarm data record element and an identifier corresponding to a site included in site data 320A. In some embodiments, individual alarm data AD1-ADK include multiple alarm data records or data record elements representing a predetermined time span relative to one or more times at which a value of the network performance indicator has the predetermined relationship to the first threshold level.

In various embodiments, NMS 170 is configured to display user interface modules 300A and 300B separately, simultaneously, or as a single user interface module.

In some embodiments, NMS 170 is configured to, in operation, receive user input usable to define the attributes corresponding to generation of the annotations, e.g., annotations 230A and/or 230B, and the second user interface module, e.g., user interface modules 300A and/or 300B. In some embodiments, the attributes are referred to as network offender attributes.

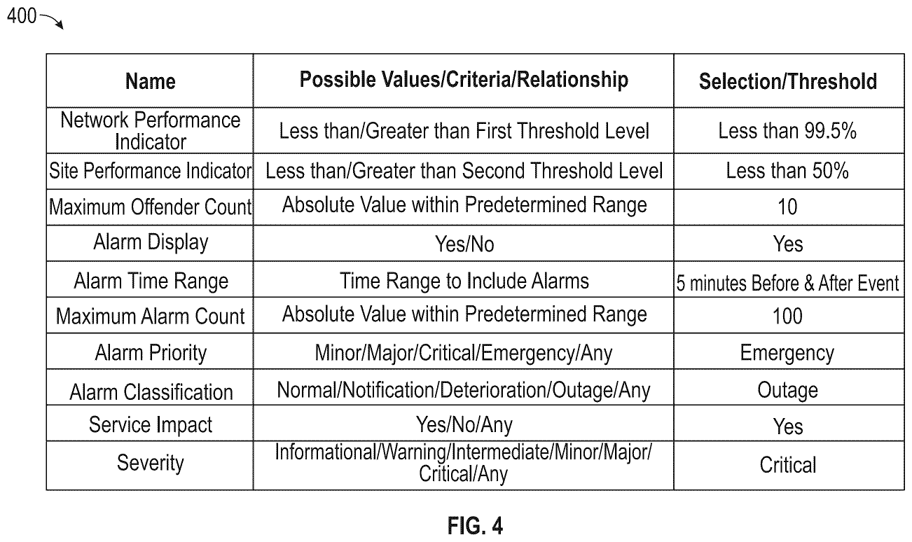

FIG. 4 illustrates network offender identification attributes 400 according to at least one embodiment. Network offender identification attributes 400 are non-limiting examples provided for the purpose of illustration. Other sets of network offender identification attributes are within the scope of the present disclosure.

In the embodiment depicted in FIG. 4, network offender identification attributes 400 include a total of ten configuration attributes, each attribute including a name, possible values/criteria/relationship, and selection/threshold elements. In various embodiments, network offender identification attributes 400 include fewer or greater than ten configuration attributes.

A network performance indicator attribute includes the name of the network performance indicator, e.g., availability, for which NMS 170 is configured to generate at least one annotation and second user interface module. The attribute includes the predetermined relationship choice of less than or greater than the first threshold level, and a user selection of less than 99.5%.

A site performance indicator attribute includes the name of the site performance indicator (corresponding to the network performance indicator) for which NMS 170 is configured to include in the at least one annotation and second user interface module. The attribute includes the predetermined relationship choice of less than or greater than the second threshold level, and a user selection of less than 50%.

A maximum offender count attribute includes a predetermined range of a maximum total number of sites for which NMS 170 is configured to include site data and a user selection of an absolute value of 10.

An alarm display attribute include a choice of whether NMS 170 is configured to include alarm data and a user selection of yes.

An alarm time range attribute includes a time range within which NMS 170 is configured to include the alarm data and a user selection of 5 minutes before and after one or more events corresponding to one or more values of the network performance indicator value having the predetermined relationship to the first threshold level. In various embodiments, an event corresponds to one or more of the first, last, midpoint, or other time at which values of the network performance indicator have the predetermined relationship to the first threshold level.

A maximum alarm count attribute includes a predetermined range of a maximum total number of alarms for which NMS 170 is configured to include alarm data and a user selection of an absolute value of 100.

An alarm priority attribute includes a predetermined alarm priority choice of minor/major/critical/emergency/any and a user selection of emergency.

An alarm classification attribute includes a predetermined alarm classification choice of normal/notification/deterioration/outage/any and a user selection of outage.

A service impact attribute includes a predetermined service impact choice of yes/no/any and a user selection of yes.

A severity attribute includes a predetermined severity choice of informational/warning/intermediate/minor/major/critical/any and a user selection of critical.

In some embodiments, one or more attributes include default selections, e.g., selections corresponding to the highest levels of filtering and thereby the least amount of displayed data.

In some embodiments, network offender identification attributes 400 include one or more additional attributes, e.g., a time range (relative to the one or more events) to include sites based on site performance indicator values having the predefined relationship to the second threshold level.

In some embodiments, NMS 170 is configured to receive separate user selections of each attribute corresponding to each network performance indicator of multiple network performance indicators. In some embodiments, NMS 170 is configured to receive a given user selection applicable to more than one network performance indicator, e.g., a selection to include displayed alarm data for all network performance indicator types.

By the configuration discussed above, NMS 170 is capable of displaying trend data of a network performance indicator in a first user interface module, and in response to a value of the network performance indicator having a predefined relationship to a first threshold level, activating an annotation to the first user interface module, the annotation including a representation of a value of the performance indicator of a site having the predefined relationship to a second threshold level, and in some embodiments including an alarm count. NMS 170 is further capable of displaying performance data including the site performance indicator and/or individual alarm data in a second user interface module in response to a user input associated with the annotation.

By including the annotation linked to site-based performance data in the trend data display, NMS 170 enables significant reduction of the time required to identify a source (offender) of a network performance indicator being outside a target value compared to approaches in which trend data displays do not include such annotations. Compared to other approaches in which iterative filtering of trend data is used to identify network offenders, NMS 170 further enables system resource loading to be reduced. In some embodiments, compared to approaches in which performance indicator data and alarm data are separately accessed, NMS 170 further improves network offender identification efficiency by including alarm data in the performance data.

FIG. 5 is a flowchart of network offender identification method 500, in accordance with some embodiments. Network offender identification method 500, also referred to as method 500 in some embodiments, is operable on a network, e.g., network 100 and/or a network management system, e.g., NMS 170 each discussed above with respect to FIGS. 1-4.

Additional operations may be performed before, during, between, and/or after the operations of method 500 depicted in FIG. 5, and some other operations may only be briefly described herein. In some embodiments, other orders of operations of method 500 are within the scope of the present disclosure. In some embodiments, one or more operations of method 500 are not performed. In some embodiments, the operations of method 500 are included in another method, e.g., a method of operating a network manager.

In some embodiments, some or all of the operations of method 500 discussed below are capable of being performed automatically, e.g., by NMS 170 discussed above with respect to FIGS. 1-4 and/or by using processing circuitry 602 discussed below with respect to FIG. 6.

At operation 510, in some embodiments, user selections of network offender identification attributes are received. In some embodiments, receiving the user selections includes receiving user input through a user interface, e.g., user interface 620 discussed above with respect to FIG. 6. In some embodiments, receiving the user selections includes accessing stored selection information, e.g., from memory 604 or through network interface 612 discussed above with respect to FIG. 6.

In some embodiments, receiving the user selections includes receiving user selections of network offender identification attributes 400 discussed above with respect to FIG. 4.

At operation 520, trend data of a network is displayed in a first user interface module. Displaying the trend data includes using a network manager, e.g., NMS 170 discussed above with respect to FIGS. 1-4, to display a graphical representation of values of a network performance indicator, e.g., a KPI, over time.

In some embodiments, displaying the trend data in the first user interface module includes displaying trend data 220 in user interface module 200 discussed above with respect to FIG. 2.

At operation 530, an annotation to the first user interface module is activated in response to a value of the network performance indicator having a predefined relationship to a first threshold level. Activating the annotation to the first user interface module includes using the network manager to activate one or more annotations as discussed above with respect to NMS 170, annotations 230A and 230B, and FIGS. 1-4.

In some embodiments, activating the annotation to the first user interface module includes receiving a user input associated with the trend data corresponding to the network performance indicator value having the predefined relationship to the first threshold level, e.g., as discussed above with respect to FIGS. 1-4.

At operation 540, performance data of the site of the plurality of sites are displayed in a second user interface module in response to a user input associated with the annotation. Displaying the performance data includes using the network manager to display the performance indicator and/or alarm data of the site of the plurality of sites as discussed above with respect to NMS 170, user interface modules 300A and 300B, and FIGS. 1-4.

At operation 550, in some embodiments, a network troubleshooting operation is performed based on some or all of the displayed performance data. In some embodiments, performing the network troubleshooting operation includes using a network manager, e.g., NMS 170 discussed above with respect to FIGS. 1-4.

In various embodiments, performing the network troubleshooting operation includes performing one or more of an adjusting, reconfiguring, resetting, rebooting, or other suitable operation on one or more network elements at one or more network sites associated with the displayed performance data.

By executing some or all of the operations of method 500, a network, e.g., network 100 discussed above, including a network manager, e.g., NMS 170 discussed above, configured to execute some or all of method 500 is thereby capable of performing network offender identification so as to realize the benefits discussed above with respect to network 100 and NMS 170.

FIG. 6 is a functional block diagram of a computer or processor-based system 600 upon which or by which an embodiment is implemented.

Processor-based system 600 is programmed to facilitate network offender identification, as described herein, and includes, for example, bus 608, processing circuitry 602, also referred to a processor 602 in some embodiments, and memory 604 components.

In some embodiments, processor-based system 600 includes a communication mechanism such as bus 608 for transferring information and/or instructions among the components of processor-based system 600. Processing circuitry 602 is connected to bus 608 to obtain instructions for execution and process information stored in, for example, memory 604. In some embodiments, processing circuitry 602 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of processing circuitry 602. Similarly, an ASIC is configurable to perform specialized functions not easily performed by a more general-purpose processor. Other specialized components to aid in performing the functions described herein optionally include one or more field programmable gate arrays (FPGA), one or more controllers, or one or more other special-purpose computer chips.

In one or more embodiments, processing circuitry (or multiple processors) 602 performs a set of operations on information as specified by a set of instructions stored in memory 604 related to network application implementation. The execution of the instructions causes the processor to perform specified functions.

Processing circuitry 602 is also electrically coupled to an I/O interface 610 by bus 608. A network interface 612 is also electrically connected to processing circuitry 602 by bus 608. Network interface 612 is connected to a network 614, so that processing circuitry 602 and computer readable storage medium 604 are capable of connecting to external elements by network 614. Processor 602 is configured to execute computer program code 606 encoded in computer readable storage medium 604 in order to cause system 600 to be usable for performing a portion or all of the operations as described in method 300. In some embodiments, network 614 is not part of system 600. In some embodiments, network 614 is an embodiment of some or all of network 100 discussed above with respect to FIG. 1.

Processing circuitry 602 and accompanying components are connected to memory 604 via bus 608. Memory 604 includes one or more of dynamic memory (e.g., RAM, magnetic disk, writable optical disk, or the like) and static memory (e.g., ROM, CD-ROM, or the like) for storing executable instructions that when executed perform the operations described herein to facilitate automated network configuration. Memory 604 also stores the data associated with or generated by the execution of the operations.

In one or more embodiments, memory 604, such as a random-access memory (RAM) or any other dynamic storage device, stores information including processor instructions for facilitating network application implementation. Dynamic memory allows information stored therein to be changed. RAM allows a unit of information stored at a location called a memory address to be stored and retrieved independently of information at neighboring addresses. Memory 604 is also used by processing circuitry 602 to store temporary values during execution of processor instructions. In various embodiments, memory 604 includes a read only memory (ROM) or any other static storage device coupled to bus 608 for storing static information, including instructions, that is not capable of being changed by processing circuitry 602. Some memory is composed of volatile storage that loses the information stored thereon when power is lost. In some embodiments, memory 604 includes a non-volatile (persistent) storage device, such as a magnetic disk, optical disk, or flash card, for storing information, including instructions, that persists even when system 600 is turned off or otherwise loses power.

The term “computer-readable medium” as used herein refers to any medium that participates in providing information to processing circuitry 602, including instructions 606 for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer reads. The term computer-readable storage medium is used herein to refer to a computer-readable medium.

Instructions 606 include network manager 616 including performance monitor 618, which correspond to the network management functions of NMS 170 discussed above with respect to FIGS. 1-5 and are therefore not further discussed. Instructions 606 also include a user interface 620, one or more sets of instructions configured to allow effective operation and control of system 600 by a user. In some embodiments, user interface 620 is configured to operate though one or more layers, including a human-machine interface (HMI) that interfaces machines with physical input hardware such as keyboards, mice, or game pads, and output hardware such as computer monitors, speakers, printers, and other suitable user interfaces. In some embodiments, user interface 620 includes a GUI.

System 600 includes I/O interface 610. I/O interface 610 is coupled to external circuitry. In some embodiments, I/O interface 610 includes a keyboard, keypad, mouse, trackball, trackpad, and/or cursor direction keys for communicating information and commands to processing circuitry 602.

System 600 also includes network interface 612 coupled to processing circuitry 602. Network interface 612 allows system 600 to communicate with network 614, to which one or more other computer read circuits are connected. Network interface 612 includes wireless network interfaces such as BLUETOOTH, WIFI, WIMAX, GPRS, or WCDMA; or wired network interface such as ETHERNET, USB, or IEEE-884.

System 600 is configured to receive information related to performance monitor 618 through I/O interface 610 and/or network interface 612. The information is transferred to processing circuitry 602 by bus 608, and is then stored in computer readable medium 604 as performance monitor 618. System 600 is configured to receive and output information using user interface 620 through I/O interface 610 and/or network interface 612.

In at least one embodiment, separate instances of instructions 606 are executed on or distributed across any number of separate computer systems. Thus, although certain steps have been described as being performed by certain devices, software programs, processes, or entities, this need not be the case. A variety of alternative implementations is within the scope of the present disclosure.

In some embodiments, a method includes displaying trend data of a network in a first user interface module, wherein the network includes a plurality of sites, each site of the plurality of sites generates a corresponding performance indicator, and the trend data include values of a network performance indicator corresponding to the performance indicators of the plurality of sites, in response to a network performance indicator value having a predefined relationship to a first threshold level, activating an annotation to the first user interface module, wherein the annotation includes a representation of a value of the performance indicator of a site of the plurality of sites having the predefined relationship to a second threshold level, and in response to a user input associated with the annotation, displaying performance data of the site of the plurality of sites in a second user interface module. In some embodiments, the performance indicator of the network and each site of the plurality of sites includes an availability, accessibility, retainability, integrity, or mobility indicator. In some embodiments, the performance data of the site of the plurality of sites include a value of the performance indicator of the site of the plurality of sites. In some embodiments, the annotation includes an alarm count corresponding to the site of the plurality of sites. In some embodiments, the performance data of the site of the plurality of sites include individual alarm data corresponding to the site of the plurality of sites. In some embodiments, the alarm count is based on an alarm time range and/or alarm selection criteria. In some embodiments, activating the annotation to the first user interface module includes receiving a user input associated with the trend data corresponding to the network performance indicator value having the predefined relationship to the first threshold level. In some embodiments, the method includes receiving user selections of each of the predefined relationship, the first threshold level, the second threshold level, and whether to include alarm data in the annotation.

In some embodiments, a system includes a memory storing computer-readable instructions and a processor connected to the memory, wherein the computer-readable instructions and the processor are configured to cause the system to display trend data of a network in a first user interface module, wherein the network includes a plurality of sites, each site of the plurality of sites generates a corresponding performance indicator, and the trend data include values of a network performance indicator corresponding to the performance indicators of the plurality of sites, in response to a network performance indicator value having a predefined relationship to a first threshold level, activate an annotation to the first user interface module, wherein the annotation includes a representation of a value of the performance indicator of a site of the plurality of sites having the predefined relationship to a second threshold level, and in response to a user input associated with the annotation, display performance data of the site of the plurality of sites in a second user interface module. In some embodiments, the computer-readable instructions and the processor are configured to further cause the system to display the trend data including the values of the network performance indicator being one of an availability, accessibility, retainability, integrity, or mobility indicator. In some embodiments, the computer-readable instructions and the processor are configured to further cause the system to display the performance data of the site of the plurality of sites including a value of the performance indicator of the site of the plurality of sites. In some embodiments, the computer-readable instructions and the processor are configured to further cause the system to activate the annotation including an alarm count corresponding to the site of the plurality of sites, and display the performance data of the site of the plurality of sites including individual alarm data corresponding to the site of the plurality of sites. In some embodiments, computer-readable instructions and the processor are configured to further cause the system to activate the annotation by further receiving a user input associated with the trend data corresponding to the network performance indicator value having the predefined relationship to the first threshold level. In some embodiments, the computer-readable instructions and the processor are configured to further cause the system to receive user selections of each of the predefined relationship, the first threshold level, the second threshold level, and whether to include alarm data in the annotation.

In some embodiments, a computer-readable medium includes instructions executable by a controller of a system to cause the system to perform operations including displaying trend data of a network in a first user interface module, wherein the network includes a plurality of sites, each site of the plurality of sites generates a corresponding performance indicator, and the trend data include values of a network performance indicator corresponding to the performance indicators of the plurality of sites, in response to a network performance indicator value having a predefined relationship to a first threshold level, activating an annotation to the first user interface module, wherein the annotation includes a representation of a value of the performance indicator of a site of the plurality of sites having the predefined relationship to a second threshold level, and in response to a user input associated with the annotation, displaying performance data of the site of the plurality of sites in a second user interface module. In some embodiments, the instructions are executable by the controller of the system to further cause the system to display the trend data including the values of the network performance indicator being one of an availability, accessibility, retainability, integrity, or mobility indicator. In some embodiments, the instructions are executable by the controller of the system to further cause the system to display the performance data of the site of the plurality of sites including a value of the performance indicator of the site of the plurality of sites. In some embodiments, the instructions are executable by the controller of the system to further cause the system to activate the annotation including an alarm count corresponding to the site of the plurality of sites, and display the performance data of the site of the plurality of sites including individual alarm data corresponding to the site of the plurality of sites. In some embodiments, the instructions are executable by the controller of the system to further cause the system to activate the annotation by further receiving a user input associated with the trend data corresponding to the network performance indicator value having the predefined relationship to the first threshold level. In some embodiments, the instructions are executable by the controller of the system to further cause the system to receive user selections of each of the predefined relationship, the first threshold level, the second threshold level, and whether to include alarm data in the annotation.

Additionally, those having ordinary skill in the art readily recognize that the techniques described above are able to be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method executed by a processor, the method comprising:
displaying trend data of a network in a first user interface module, wherein
the network comprises a plurality of sites,
each site of the plurality of sites generates a corresponding performance indicator, and
the trend data comprise values of a network performance indicator corresponding to the performance indicators of the plurality of sites;
in response to a network performance indicator value having a predefined relationship to a first threshold level, activating an annotation to the first user interface module, wherein the annotation comprises a representation of a value of the performance indicator of a site of the plurality of sites having the predefined relationship to a second threshold level; and
in response to a user input associated with the annotation, displaying performance data of the site of the plurality of sites in a second user interface module.

2. The method of claim 1, wherein the performance indicator of the network and each site of the plurality of sites comprises an availability, accessibility, retainability, integrity, or mobility indicator.

3. The method of claim 1, wherein the performance data of the site of the plurality of sites comprise a value of the performance indicator of the site of the plurality of sites.

4. The method of claim 1, wherein the annotation further comprises an alarm count corresponding to the site of the plurality of sites.

5. The method of claim 4, wherein the performance data of the site of the plurality of sites comprise individual alarm data corresponding to the site of the plurality of sites.

6. The method of claim 4, wherein the alarm count is based on an alarm time range and/or alarm selection criteria.

7. The method of claim 1, wherein the activating the annotation to the first user interface module comprises receiving a user input associated with the trend data corresponding to the network performance indicator value having the predefined relationship to the first threshold level.

8. The method of claim 1, further comprising receiving user selections of each of the predefined relationship, the first threshold level, the second threshold level, and whether to include alarm data in the annotation.

9. A system comprising:
a memory storing computer-readable instructions; and
a processor connected to the memory, wherein the computer-readable instructions and the processor are configured to cause the system to:
display trend data of a network in a first user interface module, wherein
the network comprises a plurality of sites,
each site of the plurality of sites generates a corresponding performance indicator, and
the trend data comprise values of a network performance indicator corresponding to the performance indicators of the plurality of sites;
in response to a network performance indicator value having a predefined relationship to a first threshold level, activate an annotation to the first user interface module, wherein the annotation comprises a representation of a value of the performance indicator of a site of the plurality of sites having the predefined relationship to a second threshold level; and
in response to a user input associated with the annotation, display performance data of the site of the plurality of sites in a second user interface module.

10. The system of claim 9, wherein the computer-readable instructions and the processor are configured to further cause the system to:
display the trend data comprising the values of the network performance indicator being one of an availability, accessibility, retainability, integrity, or mobility indicator.

11. The system of claim 9, wherein the computer-readable instructions and the processor are configured to further cause the system to:
display the performance data of the site of the plurality of sites comprising a value of the performance indicator of the site of the plurality of sites.

12. The system of claim 9, wherein the computer-readable instructions and the processor are configured to further cause the system to:
activate the annotation comprising an alarm count corresponding to the site of the plurality of sites; and
display the performance data of the site of the plurality of sites comprising individual alarm data corresponding to the site of the plurality of sites.

13. The system of claim 9, wherein the computer-readable instructions and the processor are configured to further cause the system to:
activate the annotation by further receiving a user input associated with the trend data corresponding to the network performance indicator value having the predefined relationship to the first threshold level.

14. The system of claim 9, wherein the computer-readable instructions and the processor are configured to further cause the system to:
receive user selections of each of the predefined relationship, the first threshold level, the second threshold level, and whether to include alarm data in the annotation.

15. A computer-readable medium comprising instructions executable by a controller of a system to cause the system to perform operations comprising:
displaying trend data of a network in a first user interface module, wherein
the network comprises a plurality of sites,
each site of the plurality of sites generates a corresponding performance indicator, and
the trend data comprise values of a network performance indicator corresponding to the performance indicators of the plurality of sites;
in response to a network performance indicator value having a predefined relationship to a first threshold level, activating an annotation to the first user interface module, wherein the annotation comprises a representation of a value of the performance indicator of a site of the plurality of sites having the predefined relationship to a second threshold level; and
in response to a user input associated with the annotation, displaying performance data of the site of the plurality of sites in a second user interface module.

16. The computer-readable medium of claim 15, wherein the instructions are executable by the controller of the system to further cause the system to:
display the trend data comprising the values of the network performance indicator being one of an availability, accessibility, retainability, integrity, or mobility indicator.

17. The computer-readable medium of claim 15, wherein the instructions are executable by the controller of the system to further cause the system to:
display the performance data of the site of the plurality of sites comprising a value of the performance indicator of the site of the plurality of sites.

18. The computer-readable medium of claim 15, wherein the instructions are executable by the controller of the system to further cause the system to:
activate the annotation comprising an alarm count corresponding to the site of the plurality of sites; and
display the performance data of the site of the plurality of sites comprising individual alarm data corresponding to the site of the plurality of sites.

19. The computer-readable medium of claim 15, wherein the instructions are executable by the controller of the system to further cause the system to:
activate the annotation by further receiving a user input associated with the trend data corresponding to the network performance indicator value having the predefined relationship to the first threshold level.

20. The computer-readable medium of claim 15, wherein the instructions are executable by the controller of the system to further cause the system to:
receive user selections of each of the predefined relationship, the first threshold level, the second threshold level, and whether to include alarm data in the annotation.
